(19) United States
(12) Patent Application Publication
(10) Pub. No.: US 2024/0268380 A1
(43) Pub. Date: Aug. 15, 2024

(54) USE OF ESSENTIAL OILS AS BIOSTIMULANTS FOR MYCELIA AND MUSHROOMS

(71) Applicant: MYCELIANCE, Les-Ponts-De-Ce (FR)

(72) Inventor: Jérémie MALLET, Les-Ponts-De-Ce (FR)

(73) Assignee: MYCELIANCE, Les-Ponts-De-Ce (FR)

(21) Appl. No.: 18/569,467

(22) PCT Filed: Jun. 14, 2022
(86) PCT No.: PCT/EP2022/066214

§ 371 Date: Dec. 12, 2023

(30) Foreign Application Priority Data
Jun. 17, 2021 (FR) FR2106414

(51) Int. Cl. A01N 27/00; A01G 18/00; A01G 18/40; A01N 65/06; A01N 65/10; A01P 21/00

(52) U.S. Cl. CPC A01N 27/00; A01G 18/00; A01G 18/40; A01N 65/06; A01N 65/10; A01P 21/00

(57) ABSTRACT

The use of particular terpenes, or of essential oils that are mainly composed thereof, as biostimulants in the production of mycelia and the cultivation of mushrooms. More particular, the invention relates to the use of at least one beta-pinene, delta-3-carene or beta-phellandrene chemotyped essential oil, or of at least one terpene selected from beta-pinene, delta-3-carene or beta-phellandrene, or one of the mixtures thereof, for stimulating the development and growth of mycelia and of edible mushrooms.

The present invention relates to the use of essential oils as biostimulants in the production of mycelia and the cultivation of mushrooms. More particularly, the invention relates to the use of particular terpenes, or of essential oils that are mainly composed thereof, in stimulating the development and growth of mycelia and edible mushrooms.

Edible mushrooms have been used for ever by humans, in particular for their food qualities or their medicinal powers. There are numerous varieties of mushrooms but the most cultivated in the world are the portobello mushroom (Agaricus bisporus), oyster mushrooms (Pleurotus ostreaus, Pleurotus eryngii, etc.) and the shiitake (Lentinula edodes). The portobello mushroom alone represents more than 40% of the world market, oyster mushrooms 25% and the shiitake 15%. The main actors in the market on the world scale are China with 50% of the production, the United States and Europe.

On the industrial scale, the method for producing mushrooms can be broken down into two steps: the first relates to the obtaining of inoculum of mycelia, the second relates to the cultivation strictly speaking of the mushrooms, from the mycelia obtained during the first step.

These two steps can be performed independently by different actors, the first by a producer of mycelia, the second by a mushroom grower, or by one and the same actor, the mushroom grower.

Obtaining inoculum of mycelia, begins with the inoculation of a sterilised culture medium using spores or a fragment of inoculum. The culture medium may be agar, such as agar dextrosed by potato (PDA, potato dextrose agar), a liquid medium such as broth dextrosed by potato (PDB, potato dextrose broth), or any other nutritive solution containing a gelling agent or not. The development and growth of the mycelium on its culture medium is variable but generally extends from 7 to 28 days, depending on the strain of mushroom. Once the mycelium has completely colonised the culture medium, a fragment of the culture medium is then taken for inoculating a colonisation substrate. An adapted colonisation substrate may be synthetic, or usually composed of cereals, generally rye, millet, sorghum, wheat, barley, rice or oats, previously sterilised and packaged in jars or culture bags.

The mycelium inoculum thus obtained is next used in culturing and producing mushrooms. The inoculum is therefore used for seeding a fructification substrate.

In the case of the portobello mushroom, the fructification substrate is a compost generally composed of straw and animal droppings, copiously watered to guarantee maturation thereof during two to three weeks. The fructification substrate is next pasteurised for a few days with temperatures decreasing from 60 to 40° C. The fructification substrate is seeded after pasteurising, for example using a spawning device, by mixing the inoculum contained in its colonisation substrate and the fructification substrate. An incubation period follows during which the inoculated fructification substrates are placed in a closed room, the temperature, humidity and oxygen of which are controlled for two weeks. The temperature is maintained from 22 to 25° C. The subsequent step is roughing—in, which consists in covering the fructification substrate with an adapted layer of earth. The roughing—in earth is for example a mixture of freestone, ground and disinfected, and horticultural peat. After a controlled temperature drop, the first mushroom heads emerge from the fructification substrate, and harvest can then commence and last for two to three weeks.

These methods for obtaining inoculum and producing mushrooms thus extend over several weeks, in particular because of the time necessary for the various strains of mycelia to colonise their substrates. The development and growth of the mycelia can furthermore be disturbed by various factors, such as a variation in parameters of the cultivation conditions. The rates of growth of the mycelia can thus become a limiting factor extending the inocula production times for the producers and/or extending the mushroom harvest times for the mushroom growers. Thus the entire mushroom production chain may be impacted.

The use of biostimulants in agricultural production methods is flourishing. Biostimulants are substances capable of stimulating the metabolism of the plant, or of a mushroom, and the natural processes thereof of absorbing nutrients. More precisely, Regulation (EU) 2019/1009 of the European Parliament and of the Council of 5 Jun. 2019 that came into force on 22 Jul. 2022 defines a biostimulant as: “a product that stimulates the nutrition processes of plants independently of the nutritive elements that it contains, for the purpose of improving one or more of the following characteristics of the plants or of their rhizosphere:
a) efficacy of use of nutritive elements
b) tolerance to abiotic stress
c) qualitative characteristics
d) availability of nutritive elements confined in the soil or the rhizosphere.

The aim of the present invention is thus to identify and propose biostimulants that are effective in the methods for producing inoculum of mycelia and in the methods for cultivating mushrooms from inoculum of mycelia. In particular, the biostimulants according to the invention should make it possible to shorten the times needed for producing mycelia inocula and cultivating mushrooms or, at the least, to avoid extending these times. Finally, the biostimulants according to the invention should be usable in conventional inoculum-production and mushroom-production methods.

For this purpose, the invention relates to the use of at least one beta-pinene, delta-3-carene or beta-phellandrene chemotyped essential oil, or one of the mixtures thereof, for stimulating the development and growth of a mycelium or of a mushroom.

As is known, the chemotype of an essential oil indicates the main component of the chemical composition of the essential oil. This component is generally present in a proportion greater than 20% of the total volume used during chemical analysis thereof.

Alternatively to the use of the essential oils selected according to the invention, it is possible to extract and use the biostimulant compound or compounds of the chemical composition of the essential oil.

Thus the invention also relates to the use of at least one terpene selected from beta-pinene, delta-3-carene or beta-phellandrene, or one of the mixtures thereof, for stimulating the development and growth of a mycelium or of a mushroom.

The applicant company in fact discovered that certain terpenes, or the essential oils that are mainly composed thereof, had surprising biostimulation capabilities on the development and growth of mycelia and mushrooms, in particular when they are added to their cultivation media or their substrates, and could therefore be used in the processes and methods for obtaining mushroom inoculum or culture.

The use of natural biostimulants is a real innovation for producing mushrooms. The use of products with biostimulant effect has a major impact on the production of mycelia and mushrooms. The main limit on inoculum producers lies in fact in their ability to quickly produce, store and distribute their mycelia to mushroom producers. The use of the biostimulants according to the invention makes it possible to reduce the time between the start of the production and the distribution, thus increasing the production capacity of the producers. Likewise, during the mushroom production phase, adding biostimulants to the cultivation substrate makes it possible to increase the rate of colonisation of the substrate by the mycelia and thus to initiate fructification and to start the harvest of the mushrooms more quickly, giving rise to an increase in the production of the mushroom growers. The biostimulants can be added during the various incubation phases, up until fructification.

Thus, during tests performed on compost, the mycelia stimulated by the compounds and the essential oils selected according to the invention, an increase in the cultivation yield, an increase in the mean mass per mushroom and, in general terms, an improvement in the quality of the mushrooms harvested, were able to be observed.

The compounds and essential oils selected in the context of the invention have the particularity of having a strongly biostimulant effect over a wide range of concentrations, and therefore without risk of inhibiting effect in the event of overdosing.

The compounds and essential oils selected are also interchangeable, for example in the event of shortage of one of them.

The compounds and essential oils selected can also be combined in order to obtain, in certain cases, effects of synergy and of accentuated resilience.

The compounds and essential oils selected also make it possible to produce their effects on the growth of the mycelia and mushrooms under conditions less propitious than normal conditions, such as a reduction in the incubation temperature by 1 or 2° C. or an ageing effect. According to one embodiment of the invention, the essential oil is selected from Pinus ponderosa, Pinus mugo, Pseudotsuga menziesii, Abies balsamea, Abies alba, Picea glauca, Angelica archangelica and Ferula gummosa.

According to one embodiment of the invention, the mycelium or mushroom is selected from the basidiomycetes, in particular the portobello mushroom, oyster mushrooms and the shiitake, more particularly Agaricus bisporus, Pleurotus ostreaus, Pleurotus eryngii and Lentinula edodes When the mycelium or mushroom is Agaricus bisporus, the essential oil used is preferentially chemotyped beta-pinene, delta-3-carene or beta-phellandrene, preferentially beta-pinene.

Alternatively to the use of the essential oil, the terpene used is preferentially beta-pinene, delta-3-carene or beta-phellandrene.

In particular, when the mycelium or mushroom is Agaricus bisporus, the essential oil used is preferentially selected from Pinus ponderosa, Pinus mugo, Pseudotsuga menziesii, Abies balsamea, Abies alba, Picea glauca, Angelica archangelica and Ferula gummosa.

When the mycelium or mushroom is Pleurotus ostreaus, the essential oil used is preferentially chemotyped beta-pinene, delta-3-carene or beta-phellandrene, preferentially beta-pinene.

Alternatively to the use of the essential oil, the terpene used is preferentially beta-pinene, delta-3-carene or beta-phellandrene.

In particular, when the mycelium or mushroom is Pleurotus ostreaus, the essential oil used is preferentially selected from Pinus ponderosa, Pinus mugo, Pseudotsuga menziesii, Abies balsamea, Abies alba, Picea glauca, Angelica archangelica and Ferula gummosa.

When the mycelium or mushroom is Pleurotus eryngii, the essential oil used is preferentially chemotyped beta-pinene or beta-phellandrene, preferentially beta-pinene. Alternatively to the use of the essential oil, the terpene used is preferentially beta-pinene or beta-phellandrene.

In particular, when the mycelium or mushroom is Pleurotus eryngii the essential oil used is preferentially selected from Angelica archangelica and Ferula gummosa.

When the mycelium or mushroom is Lentinula edodes, the essential oil used is preferentially chemotyped beta-pinene. Alternatively to the use of the essential oil, the terpene used is preferentially beta-pinene.

In particular, when the mycelium or mushroom is Lentinula edodes, the essential oil used is preferentially selected from Pseudotsuga menziesii, Abies balsamea, Abies alba, Picea glauca and Ferula gummosa.

The invention also relates to a composition for biostimulating the development and growth of a mycelium or of a mushroom, which is characterised in that it comprises: a liquid solution, at least one terpene selected from delta-3-carene and beta-phellandrene, or at least one beta-pinene, delta-3-carene or beta-phellandrene chemotyped essential oil, or one of the mixtures thereof, at least one surfactant able to solubilise the terpene or terpenes, or the essential oil or oils, in the liquid solution.

Depending on the aqueous nature or other of the liquid solution, a person skilled in the art will be able to select, among the known surfactants, those able to solubilise terpenes, or essential oils, in the solution.

Preferentially, the ratio between the terpene or terpenes, or the essential oil or oils, and the surfactant or surfactants, is 1.

Advantageously, the composition according to the invention 50% composed of a least one terpene selected from delta-3-carene or beta-phellandrene, or at least one beta-pinene, delta-3-carene or beta-phellandrene chemotyped essential oil, or one of the mixtures thereof, and 50% liquid black soap.

Preferentially, the composition comprises, by way of essential oil, at least one essential oil selected from Pinus ponderosa, Pinus mugo, Pseudotsuga menziesii, Abies balsamea, Abies alba, Picea glauca, Angelica archangelica and Ferula gummosa.

The essential oils selected in the context of the invention, and the terpenes thereof, can be used simply and effectively in the conventional inoculation production and mushroom production methods, without its being necessary to make these methods more complex.

Thus the invention also relates to a method for obtaining a mycelium inoculum, characterised in that it comprises the following steps:
preparing a culture medium,
adding, to the culture medium, at least one beta-pinene, delta-3-carene or beta-phellandrene chemotyped essential oil, or at least one terpene selected from beta-pinene, delta-3-carene or beta-phellandrene, or one of the mixtures thereof, or a composition as defined previously,
inoculating the culture medium by spores or an inoculum,
optionally, growing the mycelium,
inoculating a colonisation substrate by the mycelium,
obtaining a mycelium inoculum,
packaging the inoculum.

Preferentially in the method according to the invention, the essential oil, the terpene or the composition is added to the culture medium so that the concentration of the essential oil or oils, or the concentration of the terpene or terpenes, is between 20 and 300 μL/L of culture medium.

The culture medium used is a culture medium conventionally used in producing mycelium. It is a case in particular of a liquid or agar medium, such as potato dextrose broth (PDB) or potato dextrose agar (PDA). In a known manner, the medium is sterilised in the liquid state. Once the medium is sterilised, the composition according to the invention is added and then the medium is stored in liquid form or poured into petri dishes if it contains a gelling agent. The liquid solution or the petri dishes are next inoculated with spores or solid inocula, and the method continues conventionally.

The method according to the invention makes it possible to shorten by several days the time necessary for obtaining inocula of mycelia or mushrooms able to be marketed by the producers, compared with a conventional method. The growth can be stimulated and increased by more than 50%, or even by more than 80%, compared with the growth obtained in a conventional method, i.e. without the use of terpenes or essential oils selected in the context of the invention. The stimulation of the growth can be calculated by measuring the extent or the mass of the mycelium at an instant T, compared with a reference.

Thus the invention also relates to a method for cultivating mushrooms using a mycelium inoculum, which is characterised in that it comprises the following steps:
preparing a fructification substrate,
optionally impregnating, incorporating, watering or spraying the fructification substrate with at least one beta-pinene, delta-3-carene or beta-phellandrene chemotyped essential oil, or at least one terpene selected from beta-pinene, delta-3-carene or beta-phellandrene, or one of the mixtures thereof, or with a composition as defined previously,
seeding the fructification substrate with a mycelium inoculum preferentially obtained by a method according to the invention,
incubating, with optionally watering or spraying the fructification substrate with at least one essential oil or at least one terpene or with a composition as defined previously,
fructification
harvesting

according to one embodiment of the invention, the mycelium or mushroom is selected from the basidiomycetes, in particular the portobello mushroom, oyster mushrooms and the shiitake, more particularly Agaricus bisporus, Pleurotus ostreaus, Pleurotus eryngii and Lentinula edodes.

The features of the invention mentioned above, as well as others, will emerge more clearly from the reading of the following description of example embodiments, said description being made in relation to the accompanying figures, among which:

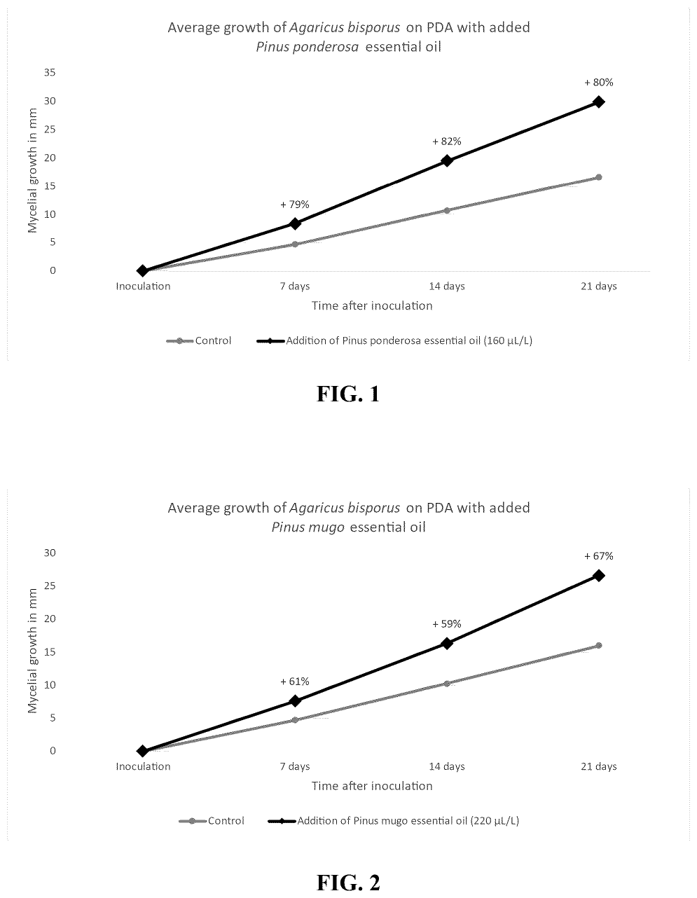

FIG. 1 is a graphical representation of the stimulation of the growth of the Agaricus bisporus mycelium on a culture medium with essential oil of Pinus ponderosa added.

FIG. 2 is a graphical representation of the stimulation of the growth of the Agaricus bisporus mycelium on a culture medium with essential oil of Pinus mugo added.

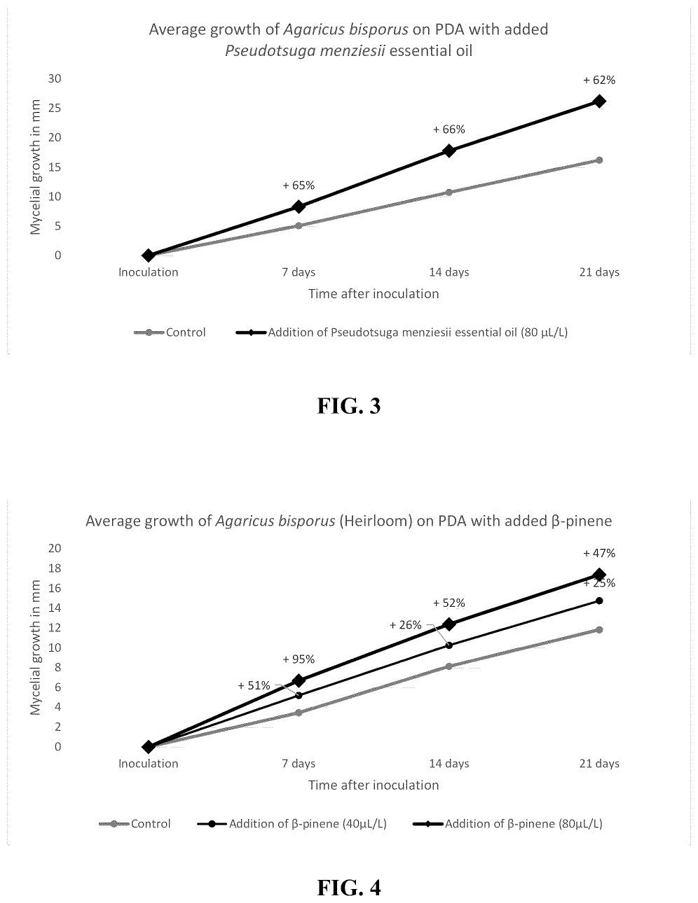

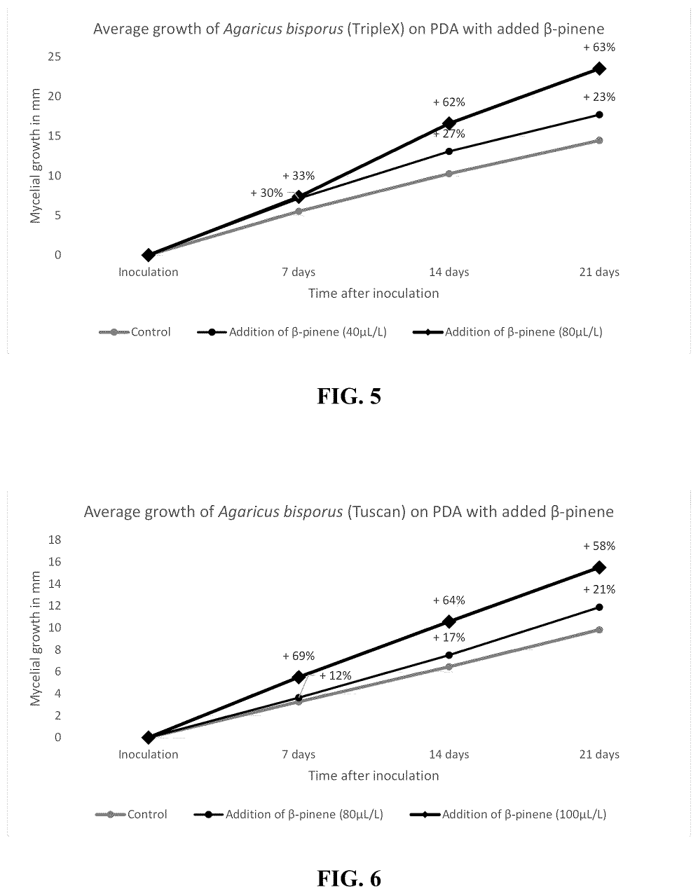

FIG. 3 is a graphical representation of the stimulation of the growth of the Agaricus bisporus mycelium on a culture medium with essential oil of Pinus menziesii added.

[FIG. 4], [FIG. 5] and [FIG. 6] are graphical representations of the stimulation of the growth of the mycelium of three strains of Agaricus bisporus on a culture medium with purified β-pinene added.

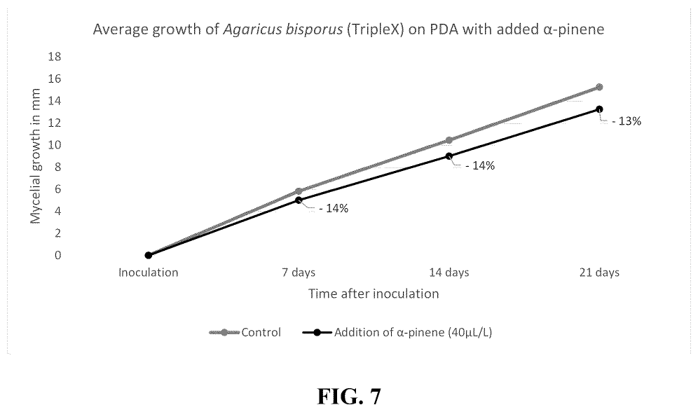

FIG. 7 is a graphical representation of the inhibition of the growth of the Agaricus bisporus mycelium on a culture medium with purified α-pinene added.

### EXAMPLE 1: EVALUATION OF THE BIOSTIMULATION OF THE GROWTH OF AGARICUS BISPORUS MYCELIUM

### 1.1 Experimental Protocol

### Preparation of a Composition of Biostimulants According to the Invention

Mixing, in a sterile container, the essential oil or oils or the terpene or terpenes selected according to the invention, with the surfactant or surfactants, in equal portions:
   To obtain a concentration of the essential oil or oils, or of the terpene or terpenes, of 100 μl for 1 litre of solution, therefore preparing 200 μl in total.

### Preparing the Culture Medium

Preparing 2 times 1 litre of PDA in accordance with the instructions of the supplier, in separate containers.
Sterilising the two solutions at the same time, 15 minutes at 121° C. in an autoclave.

### Adding, to the Culture Medium, the Composition of Biostimulants According to the Invention

Waiting until the two solutions drop in temperature, to reach approximately 40° C.
Homogenising and then pouring the composition of biostimulants, into one of the two containers.
Pouring the same volume of the surfactant or surfactants used, into the second container.
Placing under stirring, and then pouring the 2 litres of solutions into annotated petri dishes.
Placing the petri dishes in an incubator at 23° C.±1° C. and 80% humidity.

### Inoculating the Culture Medium

Inoculating all the petri dishes with the mushroom strain selected.
Re-placing the petri dishes in an incubator at 23° C.±1° C. and 80% humidity.

### Determining the Stimulation of the Growth of the Mycelium

After 7 days, tracing the contour of the mycelium under the petri dishes, with a fine marker.
Once again tracing the contour of the mycelium after 14 and 21 days following the inoculation.
Measuring its growth to within 0.5 mm, on 4 axes separated by 90°, for each petri dish.
Calculating the mean growths measured, then determining the percentage inhibition or biostimulation compared with the reference, which contains only the surfactant or surfactants, without the essential oil or oils or the terpene and terpenes use.

### 1.2 Results

The essential oils that were tested and which made it possible to stimulate the development and growth of Agaricus bisporus mycelium are presented in Table 1 below. The percentage stimulation obtained and the chemotype of each essential oil are also indicated.

The manipulations for each essential oil tested were reproduced 40 times, using the Agaricus bisporus mycelium of Heirloom make, supplied by the American company Amycel.

TABLE 1

| | | | Limits of | |
|---|---|---|---|---|
| | | | concentrations | |
| | | | (μL of EO | |
| Botanical | Genus-species | Maximum | per litre of | Chemotype of |
| family | Binomial name | stimulation | solution) | the essential oil |
| Apiaceae | Angelica archangelica | 75% | 40 to 300 μL/L | β-phellandrene |
| | Ferula gummosa | 45% | 20 to 200 μL/L | β-pinene |
| Pinaceae | Abies alba | 42% | 20 to 200 μL/L | β-pinene |
| | Abies balsamea | 59% | 20 to 200 μL/L | β-pinene |
| | Picea glauca | 35% | 20 to 100 μL/L | β-pinene |
| | Pinus mugo | 67% | 20 to 300 μL/L | δ-3-carene |
| | Pinus ponderosa | 82% | 20 to 300 μL/L | β-pinene |
| | Pseudotsuga menziesii | 66% | 20 to 200 μL/L | β-pinene |

A stimulation of the growth of the mycelia of more than 35%, compared with the controls, is noted. In particular, the essential oils of Pinus ponderosa, Angelica archangelica and Pinus mugo showed themselves to be extremely effective with a growth stimulation rate of 82%, 75% and 67% respectively. These essential oils are chemotyped [3-pinene, [3-phellandrene or 6-3-carene.

FIGS. 1, 2 and 3 illustrate the mean growths of the Agaricus bisporus mycelium on their culture medium with the addition of essential oils of Agaricus bisporus (FIG. 1), Pinus mugo (FIG. 2) and Pseudotsuga menziesii (FIG. 3).

By way of comparison, the essential oils indicated in Table 2 for their part showed an inhibiting effect, or showed no significant effect, on the growth of the Agaricus bisporus mycelium.

TABLE 2

| Botanical | Genus-species | Chemotype of |
|---|---|---|
| family | Binomial name | the essential oil |
| Anacardiaceae | Pistacia lentiscus | myrcene |
| | Schinus molle | α-phellandrene |
| Apiaceae | Trachyspermum ammi | thymol |
| Asteraceae | Artemisia dracunculus | methylchavicol |
| Cupressaceae | Cupressocyparis leylandii | α-pinene |
| | Cupressus macrocarpa | terpinene-4-ol |
| | Cupressus sempervirens | α-pinene |
| | Cryptomeria japonica | α-pinene |
| | Juniperus communis | α-pinene |
| | Juniperus oxycedrus | δ-cadinene |
| | Juniperus virginiana | α-cedrene |
| | Thuya occidentalis | α-thuyone |
| | Thuya plicata | α-thuyone |
| Geraniaceae | Pelargonium graveolens | citronnellol |
| | Pelargonium x asperum | citronnellol |
| Lamiaceae | Ocimum basilicum | methylchavicol |
| | Origanum compactum | carvacrol |
| | Origanum heracleoticum | carvacrol |
| | Origanum majorana | terpinene-4-ol |
| | Origanum majorana | cis-thujanol |
| | thujanoliferum | |
| | Satureja montana | carvacrol |
| | Thymus satureioides | borneol |
| | Thymus serpyllum | thymol |
| | Thymus vulgaris carvacroliferum | carvacrol |
| | Thymus vulgaris geranioliferum | geranyl acetate |
| | Thymus vulgaris linaloliferum | linalol |
| | Thymus vulgaris thujanoliferum | cis-thujanol |
| | Thymus vulgaris thymoliferum | thymol |
| | Thymus zygis thymoliferum | thymol |
| Lauraceae | Cinnamomum cassia | cinnamaldehyde |
| | Cinnamomum zeylanicum | cinnamaldehyde |
| Myristicaceae | Myristica fragrans | sabinene |
| Myrtaceae | Melaleuca alternifolia | terpinene-4-ol |
| | Melaleuca viridiflora | 1,8-cineole |
| Pinaceae | Abies sibirica | bornyl acetate |
| | Cedrus atlantica | β-himachalene |
| | Cedrus deodara | β-himachalene |
| | Picea mariana | bornyl acetate |
| | Picea pungens | α-pinene |
| | Pinus nigra | α-pinene |
| | Pinus pinaster | α-pinene |
| | Pinus sylvestris | α-pinene |
| | Tsuga canadensis | bornyl acetate |
| Piperaceae | Piper nigrum | β-caryophyllene |
| Poaceae | Cymbopogon citratus | neral |
| Verbenaceae | Lippia citriodora | limonene |
| Zingiberaceae | Zingiber officinalis | zingiberene |

### Example 2: Evaluation of the Biostimulation of the Growth of Pleurotus Ostreaus Mycelium

### 2.1 Experimental Protocol

### The Experimental Protocol is Identical to the One in Example]1.

### 2.2 Results

The essential oils that were tested and which made it possible to stimulate the development and growth of Pleurotus ostreaus mycelium are presented in Table 3 below. The percentage stimulation obtained and the chemotype of each essential oil are also indicated.

The manipulations for each essential oil tested were reproduced 4 times, using the Pleurotus ostreaus mycelium supplied by the Austrian company Gluckspilze.

TABLE 3

| | | | Limits of | |
|---|---|---|---|---|
| | | | concentrations | |
| | | | (μL of EO | |
| Botanical | Genus-species | Maximum | per litre of | Chemotype of |
| family | Binomial name | stimulation | solution) | the essential oil |
| Apiaceae | Angelica archangelica | 44% | 20 to 300 μL/L | β-phellandrene |
| | Ferula gummosa | 30% | 20 to 300 μL/L | β-pinene |
| Pinaceae | Abies alba | 36% | 20 to 300 μL/L | β-pinene |
| | Abies balsamea | 43% | 20 to 300 μL/L | β-pinene |
| | Picea glauca | 47% | 20 to 300 μL/L | β-pinene |
| | Pinus mugo | 52% | 20 to 300 μL/L | δ-3-carene |
| | Pinus ponderosa | 61% | 20 to 300 μL/L | β-pinene |
| | Pseudotsuga menziesii | 48% | 20 to 300 μL/L | β-pinene |

A stimulation of the growth of the mycelia of more than 30%, compared with the controls, is noted. In particular, the essential oils of Pinus ponderosa, Pinus mugo and Pseudotsuga menziesii showed themselves to be extremely effective with a growth stimulation rate of 61%, 52% and 48% respectively. These essential oils are chemotyped [3-pinene, [3-phellandrene or 6-3-carene.

### Example 3: Evaluation of the biostimulation of the growth of Pleurotus eryngii mycelium

3.1 Experimental protocol

### The Experimental Protocol is Identical to the One in Example 1.

### 3.2 Results

The essential oils that were tested and which made it possible to stimulate the development and growth of Pleurotus eryngii mycelium are presented in Table 4 below. The percentage stimulation obtained and the chemotype of each essential oil are also indicated.

The manipulations for each essential oil tested were reproduced 4 times, using the Pleurotus eryngii mycelium supplied by the Austrian company Gluckspilze.

TABLE 4

| | | | Limits of | |
|---|---|---|---|---|
| | | | concentrations | |
| | | | (μL of EO | |
| Botanical | Genus-species | Maximum | per litre of | Chemotype of |
| family | Binomial name | stimulation | solution) | the essential oil |
| Apiaceae | Angelica archangelica | 54% | 20 to 300 μL/L | β-phellandrene |
| | Ferula gummosa | 35% | 20 to 300 μL/L | β-pinene |

A stimulation of the growth of the mycelia of more than 35%, compared with the controls, is noted. In particular, the essential oils of Angelica archangelica and Ferula gummosa showed themselves to be extremely effective with a growth stimulation rate of 54% and 35% respectively. These essential oils are chemotyped [3-phellandrene or [3-pinene.

By way of comparison, the essential oils of Trachyspermum ammi chemotyped thymol, and of Artemisia dracunculus, chemotyped methylchavicol, were tested and for their part showed an inhibiting effect on the growth of the Pleurotus eryngii mycelium.

### Example 4: Evaluation of the Biostimulation of the Growth of Lentinula edodes Mycelium

### 4.1 Experimental Protocol

### The Experimental Protocol is Identical to the One in Example 1.

### 4.2 Results

The essential oils that were tested and which made it possible to stimulate the development and growth of Lentinula edodes mycelium are presented in Table 5 below. The percentage stimulation obtained and the chemotype of each essential oil are also indicated.

The manipulations for each essential oil tested were reproduced 4 times, using the Lentinula edodes mycelium supplied by the Austrian company Glickspilze.

TABLE 5

| | | | Limits of | |
|---|---|---|---|---|
| | | | concentrations | |
| | | | (μL of EO | |
| Botanical | Genus-species | Maximum | per litre of | Chemotype of |
| family | Binomial name | stimulation | solution) | the essential oil |
| Apiaceae | Ferula gummosa | 18% | 20 to 300 μL/L | β-pinene |
| Pinaceae | Abies alba | 11% | 20 to 300 μL/L | β-pinene |
| | Abies balsamea | 11% | 20 to 300 μL/L | β-pinene |
| | Picea glauca | 10% | 20 to 300 μL/L | β-pinene |
| | Pseudotsuga menziesii | 20% | 20 to 300 μL/L | β-pinene |

A stimulation of the growth of the mycelia of more than 10%, compared with the controls, is noted. In particular, the essential oils of Pseudotsuga menziesii and Ferula gummosa showed themselves to be effective with a growth stimulation rate of 20% and 18% respectively. These essential oils are all chemotyped j3-pinene.

### Example 5: Evaluation of the Biostimulation of the Growth of Mycelium of Agaricus Bisporus by βPinene

### 5.1 Experimental Protocol

The experimental protocol is identical to the one in example 1.

The tests were performed on three strains of Agaricus bisporus (of Heirloom and TripleX makes from the company Amycel and Tuscan from the company Sylvan) with the purified terpene (3-pinene.

### 5.2 Results

FIGS. 4, 5 6 illustrate the mean growths of the mycelium of Agaricus bisporus of Heirloom make (FIG. 4), of Agaricus bisporus of TripleX make (FIG. 5), of Agaricus bisporus of Tuscan make (FIG. 6), on their culture medium with purified β-pinene added, at a concentration of 40 or 80 μL/L for Agaricus bisporusd of Heirloom and TripleX makes, and at a concentration of 80 or 100 μL/L for Agaricus bisporus of make Tuscan make.

For the three strains of Agaricus bisporus a very marked effect of biostimulation of the growth of the mycelia by stimulated by β-pinene is observed, this effect being reinforced by increasing the concentration of β-pinene.

### Example 6: Comparison of the Effects of β-Pinene and α-Pinene on the Growth of the Agaricus bisporus Mycelium

### 6.1 Experimental Protocol

The experimental protocol is identical to the one in example 1.

The tests were performed on the strain of Agaricus bisporus of TripleX make from the company Amycel with the purified terpenes β-pinene α-pinene, at a concentration of 40 μL/L.

### 6.2 Results

The results presented on FIGS. 5 and 7.

This test shows the antagonist effects of these 2 terpenes on the growth of the Agaricus bisporus mycelium. This is because α-pinene produces an inhibiting effect on the growth of the mycelium whereas β-pinene produces a biostimulant effect on the growth of the mycelium, as indicated in example 5.

1. Use of at least one beta-pinene, delta-3-carene or beta-phellandrene chemotyped essential oil, or one of the mixtures thereof, for stimulating the development and growth of a mycelium or of a mushroom.

2. Use according to claim 1, wherein the essential oil is selected from Pinus ponderosa, Pinus mugo, Pseudotsuga menziesii, Abies balsamea, Abies alba, Picea glauca, Angelica archangelica and Ferula gummosa.

3. Use of at least one terpene selected from beta-pinene, delta-3-carene or beta-phellandrene, or one of the mixtures thereof, for stimulating the development and growth of a mycelium or of a mushroom.

4. Use according to claim 1, wherein the mycelium or mushroom is selected from the basidiomycetes, in particular the portobello mushroom, oyster mushrooms and the shiitake, more particularly Agaricus bisporus, Pleurotus ostreaus, Pleurotus eryngii and Lentinula edodes.

5. Composition for biostimulating the development and growth of a mycelium or of a mushroom comprising,
a liquid solution,
at least one terpene selected from delta-3-carene or beta-phellandrene, or at least one beta-pinene, delta-3-carene or beta-phellandrene chemotyped essential oil, or one of the mixtures thereof,
at least one surfactant able to solubilise the terpene or terpenes, or the essential oil or oils, in the liquid solution.

6. The composition according to claim 5, wherein the essential oil is selected from Pinus ponderosa, Pinus mugo, Pseudotsuga menziesii, Abies balsamea, Abies alba, Picea glauca, Angelica archangelica and Ferula gummosa.

7. The composition according to claim 5, wherein the ratio between the terpene or terpenes, or the essential oil or oils, and the surfactant surfactants, is 1.

8. The composition according to claim 5, wherein it is 50% composed of a least one terpene selected from delta-3-carene or beta-phellandrene, or at least one beta-pinene, delta-3-carene or beta-phellandrene chemotyped essential oil, or one of the mixtures thereof, and 50% liquid black soap.

9. A method for obtaining a mycelium inoculum, wherein the method comprises the following steps:
preparing a culture medium,
adding, to the culture medium, at least one beta-pinene, delta-3-carene or beta-phellandrene chemotyped essential oil, or at least one terpene selected from beta-pinene, delta-3-carene or beta-phellandrene, or one of the mixtures thereof, or a composition for biostimulating the development and growth of a mycelium or of a mushroom, the composition comprising:
a liquid solution,
at least one terpene selected from delta-3-carene or beta-phellandrene, or at least one beta-pinene, delta-3-3carene or beta-phellandrene chemotyped essential oil, or one of the mixtures thereof,
at least one surfactant able to solubilise the terpene or terpenes, or the essential oil or oils, in the liquid solution,
inoculating the culture medium by spores or an inoculum,
optionally, growing the mycelium,
inoculating a colonisation substrate by the mycelium,
obtaining a mycelium inoculum,
packaging the inoculum.

10. The method according to claim 9 wherein the essential oil or oils, said terpene or terpenes, or said composition, are added to the culture medium so that the concentration of the essential oil or oils, or the concentration of the terpene or terpenes, is between 20 and 300 μL/L of culture medium.

11. A method for cultivating mushrooms using a mycelium inoculum, characterised in that it comprises the following steps:
preparing a fructification substrate,
optionally impregnating, incorporating, watering or spraying the fructification substrate with at least one beta-pinene, delta-3-carene or beta-phellandrene chemotyped essential oil, or at least one terpene selected from beta-pinene, delta-3-carene or beta-phellandrene, or one of the mixtures thereof, or with a composition for biostimulating the development and growth of a mycelium or of a mushroom, the composition comprising:
a liquid solution,
at least one terpene selected from delta-3-carene or beta-phellandrene, or at least one beta-pinene, delta-3-carene or beta-phellandrene chemotyped essential oil, or one of the mixtures thereof,
at least one surfactant able to solubilise the terpene or terpenes, or the essential oil or oils, in the liquid solution
seeding the fructification substrate with a mycelium inoculum obtained by a method according to claim 9,
incubating, with optionally watering or spraying the fructification substrate with at least one essential oil or at least one terpene or a composition as defined previously,
fructification
harvesting.

12. The method according to claim 9, wherein the mycelium or mushroom is selected from the basidiomycetes, in particular the portobello mushroom, oyster mushrooms and the shiitake, more particularly Agaricus bisporus, Pleurotus ostreaus, Pleurotus eryngii and Lentinula edodes.
